(19) United States
(12) Patent Application Publication
(10) Pub. No.: US 2016/0285217 A1
(43) Pub. Date: Sep. 29, 2016

(54) UNIVERSAL SERIAL BUS (USB) PORT AND PLUG SYSTEMS

(71) Applicant: Toshiba Global Commerce Solutions Holdings Corporation, Tokyo (JP)

(72) Inventors: Timothy Crockett, Raleigh, NC (US); Stacy Arrington, Morrisville, NC (US); Jose Figueroa, Knightdale (NC)

(21) Appl. No.: 14/667,570

(22) Filed: Mar. 24, 2015

(51) Int. Cl. H01R 27/02; H01R 13/639

(52) U.S. Cl. CPC H01R 27/02; H01R 13/639

(57) ABSTRACT

Universal serial bus (USB) port and plug systems are disclosed. According to an aspect, a USB port system includes a housing having sides that define an interior therebetween. The housing also includes a first opening and a second opening defined within one of the sides. The USB port system also includes a first slot and a second slot extending from the first opening and the second opening, respectively, towards the interior and structured to receive a first USB plug and a second USB plug. The first USB plug is different than the second USB plug. A plurality of first pads are positioned within the first slot and arranged to be operably connected to the first USB plug. A plurality of second pads are positioned within the second slot and arranged to be operably connected to the second USB plug.

### CROSS REFERENCE TO RELATED APPLICATIONS

This application is related to U.S. Design Patent Application No. ______, titled UNIVERSAL SERIAL BUS (USB) PORT SYSTEM and filed simultaneously herewith, and U.S. Design Patent Application No. ______, titled UNIVERSAL SERIAL BUS (USB) PLUG SYSTEM and filed simultaneously herewith; the disclosures of which are incorporated herein by reference in their entireties.

### FIELD

Embodiments described herein relate to electrical connectors. More particularly, embodiments described herein relate to universal serial bus (USB) port and plug systems.

### BACKGROUND

USB is a connector standard that defines cables, connectors, and communication protocols used in a bus connection, communication, and power supply between computing devices and electronic devices. More particularly, USB is a serial interface that is often used in place of RS232 serial interfaces and parallel interfaces to connect peripheral devices (e.g., mice, keyboards, printers, etc.) to computers (e.g., desktop and laptop computers). Many computers are equipped with multiple USB connectors, each of which is designed to mate with a respective USB plug. A typical USB connector is configured with electrical contacts that are designed to couple to electrical contacts external to the USB connector in order to perform data transfer and power supply functions. Some of the electrical contacts of the USB connector are used to couple electrical contacts of a USB plug to the electrical circuitry of the USB connector, whereas some of the electrical contacts of the USB connector are used to couple the electrical circuitry of the USB connector to conductive traces formed on a motherboard of a computer. Electrical traces on the motherboard route electrical signals between the electrical circuitry of the USB connector and electrical circuitry mounted on the motherboard, such as, for example, a USB controller that is connected to a main processor of the computer.

USB plugs and ports are available in a variety of sizes and shapes. In addition, there are many different electrical and computing applications for USB technologies. For at least these reasons, there is a continuing need for improved USB plug and port systems of varying shapes and sizes for different applications.

### BRIEF DESCRIPTION OF THE DRAWINGS

The foregoing summary, as well as the following detailed description of various embodiments, is better understood when read in conjunction with the drawings provided herein. For the purposes of illustration, there is shown in the drawings exemplary embodiments; however, the presently disclosed subject matter is not limited to the specific methods and instrumentalities disclosed.

FIG. 1 is a top perspective view of an example USB port system in accordance with embodiments of the present disclosure;

FIG. 2 is a bottom perspective view of the USB port system shown in FIG. 1;

FIG. 3 is a top view of the USB port system shown in FIG. 1;

FIG. 4 is a side view of the USB port system shown in FIG. 1;

FIG. 5 is a front view of the USB port system shown in FIG. 1;

FIG. 6 is a side view that opposes the view of the USB port system shown in FIG. 4;

FIG. 7 is a bottom view of the USB port system shown in FIG. 1;

FIG. 8 is a cross-sectional side view of the USB port system shown in FIG. 1;

FIG. 9 is a front perspective view of an example USB plug system in accordance with embodiments of the present disclosure;

FIG. 10 is a rear perspective view of the USB plug system shown in FIG. 9;

FIG. 11 is a rear view of the USB plug system shown in FIG. 9;

FIG. 12 is a side view of the USB plug system shown in FIG. 9;

FIG. 13 is a top view of the USB plug system shown in FIG. 9;

FIG. 14 is a side view that opposes the view of the USB plug system shown in FIG. 12; and

FIG. 15 is a front view of the USB plug system shown in FIG. 9.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

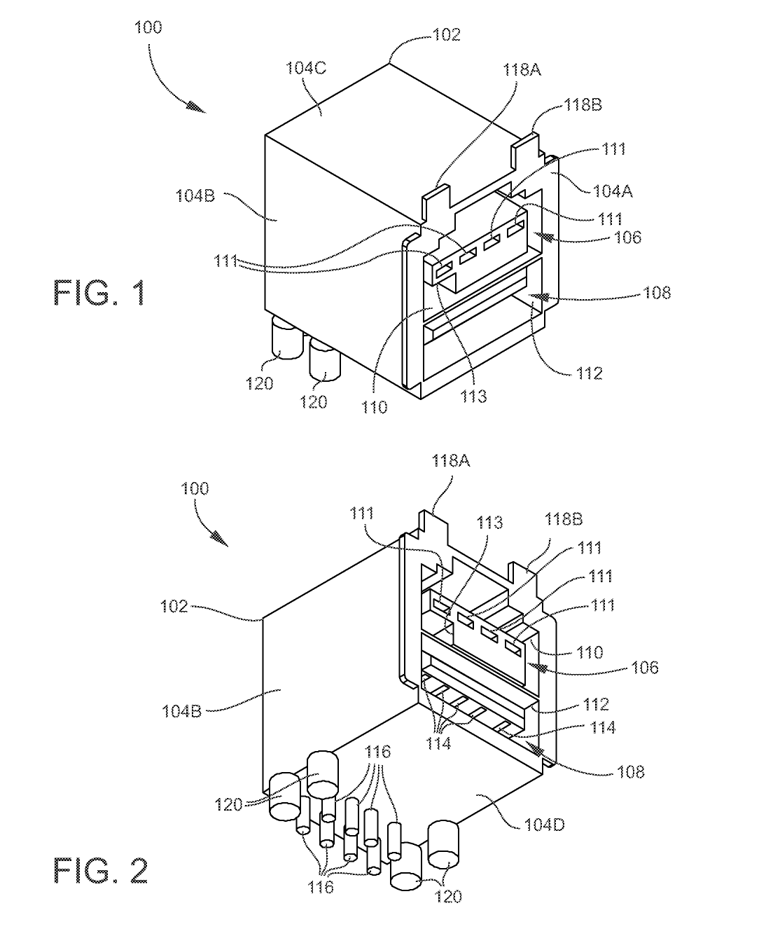

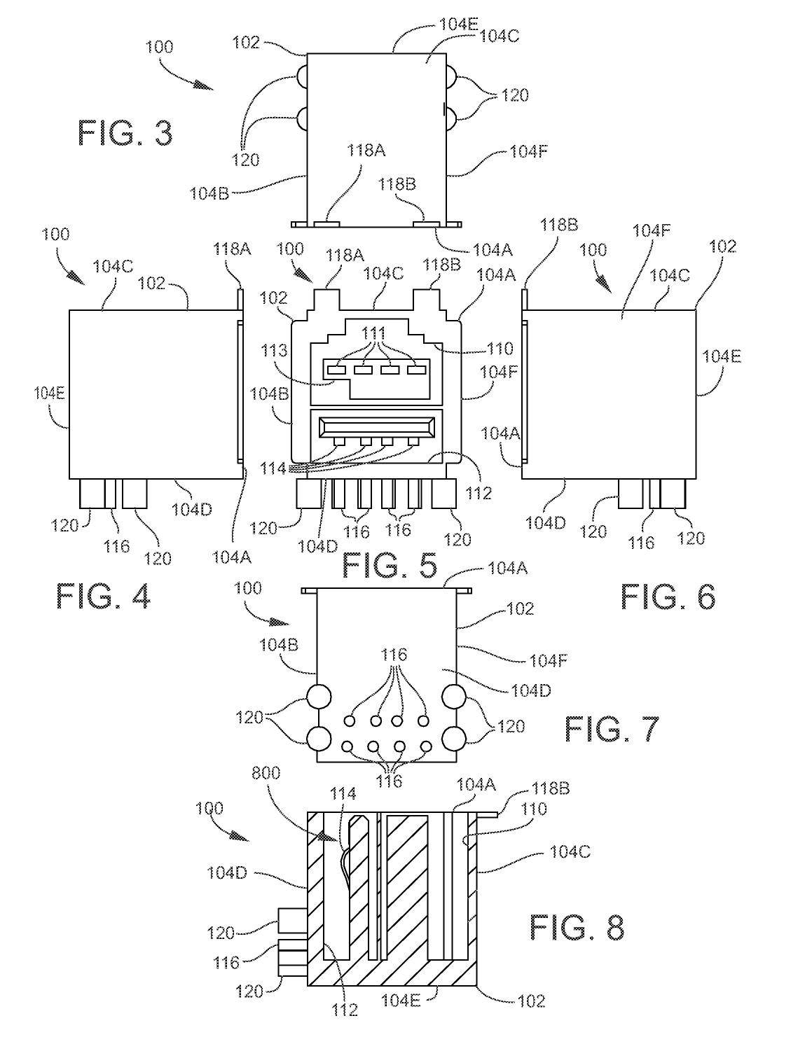

FIGS. 1-8 illustrate different views of an example USB port system 100 in accordance with embodiments of the present disclosure. Referring to FIGS. 1-8, the system 100 includes a housing 102 having sides 104A-104F. The sides of the housing 102 form an interior 800 therebetween. The housing 102 may be made of a suitable plastic or other type of rigid material as will be understood to those of skill in the art. In this example, the housing 102 is generally cubical in shape; however, it should be understood that the housing 102 may be any suitable shape depending on the application. The housing 102 may be suitably sealed for preventing entry of moisture or contaminants within the interior defined by the sides 104A-104F and shown in FIG. 8, which illustrates a cross-sectional, side view of the system 100.

Openings 106 and 108 are defined within side 104A of the housing 102 for receipt of USB plugs. In the alternative, the openings 106 and 108 and one or more other openings may be formed in the sides of the housing 102 for receipt of USB plugs or other types of plugs. In this example, the openings 106 and 108 are configured in a stacked arrangement such that the opening 106 is on top of the opening 108 when the system 100 is in an upright position as shown in FIG. 1.

The system 100 may include slots 110 and 112 formed in the interior of the housing 102 and that extend from the openings 106 and 108, respectively, towards the interior. For example, sSlots 110 and 112 are structured to receive a USB version 2 plug and a USB version 3 plug, respectively. In this example, opening 106 is sized and shaped to receive and engage a 12 Volt (V) USB version 2.0 plug. The slot 110 defines a notch 113 or stop component configured to prevent insertion of a 24 V USB plug, while permitting insertion of a 12 V USB plug.

In an alternative example, for example, the opening 106 and slot 110 may be sized and shaped to receive and engage a 24 V USB version 2.0 plug. A slot or other stop component may be formed in the slot 110 to prevent insertion of a 12 V USB plug, while permitting insertion of a 24 V USB plug. In the example above, a USB version 2 plug, a USB version 3 plug, a 12V USB plug, a 24V USB plug are described. In embodiments of the disclosure, however, various versions or types may be applied. Openings 106 and 108 may be sized and shaped to receive and engage any given USB version plug, respectively. Slots 110 and 112 also may be structured to receive and engage any given USB version plug, respectively.

Multiple pads may be positioned within the slot 106 and arranged to be operably connected to a USB version 2.0 plug of 12 V type. Particularly, the slot 106 may form multiple openings 111 wherein the pads may be positioned. Alternatively, the pads may be arranged to operably connect to any type of USB version 2 plug. The pads may be configured for carrying any suitable type of electrical signal including, but not limited to, a ground, a D+ signal, a D− signal, and a V_{CC} signal.

Multiple pads 114 are positioned within the slot 106 and arranged to be operably connected to a USB version 3.0 plug. Alternatively, the pads 114 may be arranged to operably connect to any type of USB version 3 plug. The pads 114 may be configured for carrying any suitable type of electrical signal including, but not limited to, a ground, a D+ signal, a D− signal, a V_{CC} signal, a StdA_SSRX signal, a StdA_SSRX+ signal, a ground drain, a StdA_SSTX+ signal, and a StdA_SSTX-signal. One of the pads 114 may function as a power pad for delivery of power to a USB version 3 device.

The system 100 may include USB version 2 circuitry and USB version 3 circuitry (not shown in the figures) contained within the interior of the housing 102. The circuitry may be operably connected to the pads within the openings 111 and the second pads 114. The circuitry may be configured to suitably connect the pads within the openings 111 and 114 for transmission of the USB version 2 and version 3 signals to and from pins 116 arranged on and extending from the side 104D of the housing 102. The circuitry may include multiple wires and/or other suitable components for electrically connecting the pads to the pins 116.

A locking mechanism may be suitably attached to the housing 102 for engaging and locking to a USB plug system. In this example, the locking mechanism includes members 118A and 118B configured to engage to a mating locking mechanism of a USB plug system.

The housing 102 may define multiple posts 120 for attachment of the system 100 to another component as will be understood by those of skill in the art.

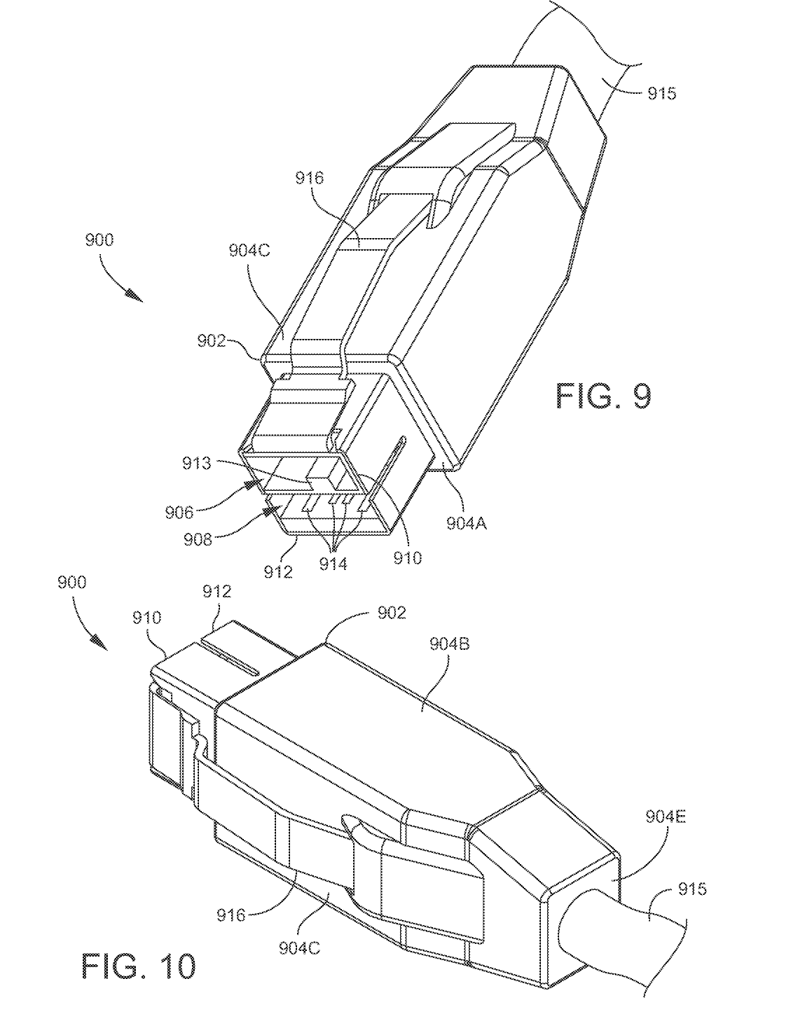

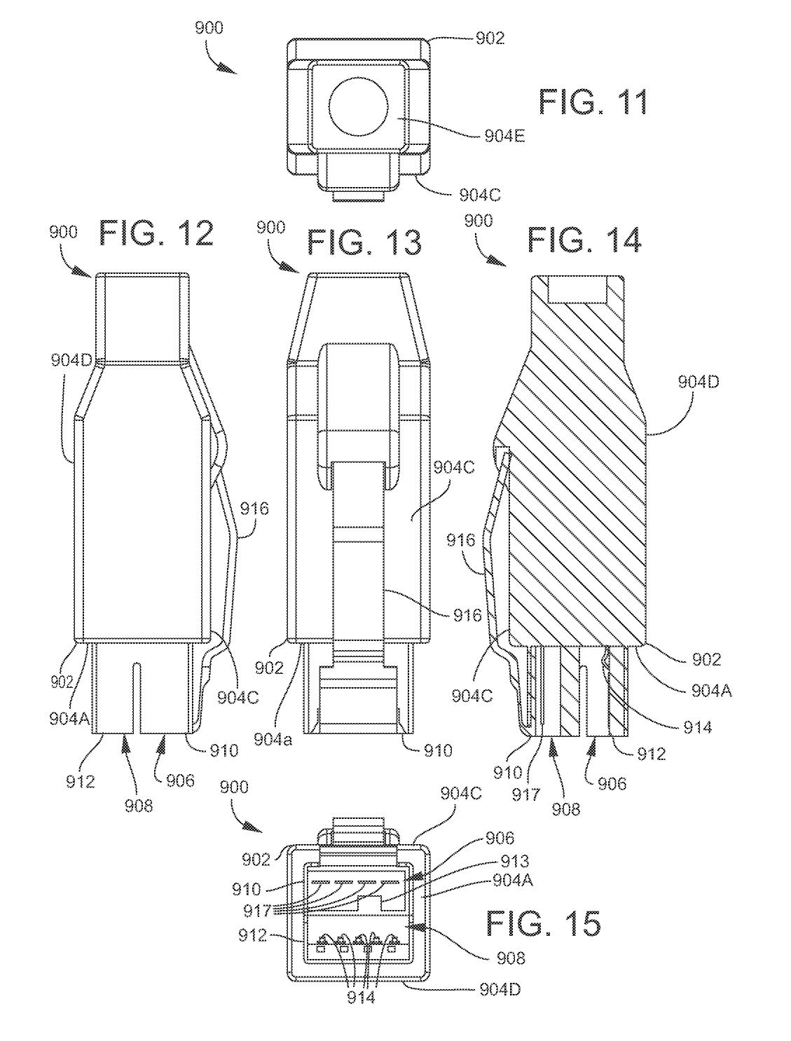

FIGS. 9-15 illustrate different views of an example USB plug system 900 in accordance with embodiments of the present disclosure. Referring to FIGS. 9-15, the system 900 includes a housing 902 having sides 904A-904F. The sides of the housing 902 form an interior therebetween. The housing 902 may be made of a suitable plastic or other type of rigid material as will be understood to those of skill in the art. In this example, the housing 902 is generally shaped as an elongated cube; however, it should be understood that the housing 902 may be any suitable shape depending on the application. The housing 902 may be suitably sealed for preventing entry of moisture or contaminants within the interior defined by the sides 904A-904F.

Openings 906 and 908 are defined within side 904A of the housing 902. In this example, the openings 906 and 908 are configured in a stacked arrangement such that the opening 906 is on top of the opening 908 when the system 900 is in an upright position as shown in FIG. 9.

Interfaces 910 and 912 extend outward from the openings 906 and 908, respectively. Interfaces 910 and 912 are structured to engage a USB version 2 port and a USB version 3 port, respectively. In this example, interface 910 is sized and shaped to engage a 24 V USB version 2.0 port. Interface 910 defines a notch 913 or stop component configured to prevent engagement with a 12 V USB port, while permitting engagement with a 24 V USB plug. For example, there may be a mating groove or notch in a 24 V USB plug that only permits engagement with that particular type of plug. Other plugs may be prevented from engaging the interface in the case that their slot does not fit to the notch 913.

In an alternative example, for example, the opening 906 and interface 910 may be sized and shaped to engage a 12 V USB version 2.0 port. A slot or other stop component may be formed in the interface 910 to prevent engagement with a 24 V USB port, while permitting engagement with a 12 V USB port.

The system 900 includes USB version 2 wiring and USB version 3 wiring that each have ends contained within the interior of the housing 902. The wiring ends are electrically connected to pads of interfaces 910 and 912. Opposing ends of the wiring may be positioned within an interior of cording 915.

Multiple pads or pins 917 are positioned within the interface 906 and arranged to be operably connected to a USB version 2.0 port of 24 V type. Alternatively, the pads may be arranged to operably connect to any type of USB version 2 plug. The pads may be configured for carrying any suitable type of electrical signal including, but not limited to, a ground, a D+ signal, a D− signal, and a V_{CC} signal.

Multiple pads 914 are positioned within the slot 106 and arranged to be operably connected to pads of a USB version 3.0 port. Alternatively, the pads 914 may be arranged to operably connect to pads of any type of USB version 3 port. The pads 914 may be configured for carrying any suitable type of electrical signal including, but not limited to, a ground, a D+ signal, a D− signal, a V_{CC} signal, a StdA_SSRX signal, a StdA_SSRX+ signal, a ground drain, a StdA_SSTX+ signal, and a StdA_SSTX− signal. One of the pads 914 may function as a power pad for delivery of power to a USB version 3 device.

The system 900 may include USB version 2 circuitry and USB version 3 circuitry (not shown in the figures) contained within the interior of the housing 902. The circuitry may be operably connected to the pins 917 and the pads 914. The circuitry may be configured to suitably connect the pins 917 and 914 for transmission of the USB version 2 and version 3 signals to and from the wire ends within the cording 915. The circuitry may include multiple wires and/or other suitable components.

A locking mechanism 916 may be suitably attached to the housing 902 for engaging and locking to a USB port system. In this example, the locking mechanism 916 can be pushed downward, such as by a finger of an operator, to release the locking mechanism when it is engaged to a mating locking mechanism of a USB port system.

While certain embodiments have been described, these embodiments have been presented by way of example only, and are not intended to limit the scope of the presently disclosed subject matter. Indeed, the novel methods, devices, and systems described herein may be embodied in a variety of other forms. Furthermore, various omissions, substitutions, and changes in the form of the methods, devices, and systems described herein may be made without departing from the spirit of the presently disclosed subject matter. The accompanying claims and their equivalents are intended to cover such forms or modifications as would fall within the scope and spirit of the presently disclosed subject matter.

What is claimed:

1. A universal serial bus (USB) port system comprising:
a housing including a plurality of sides defining an interior therebetween, and including a first opening and a second opening defined within at least one of the sides;
a first slot and a second slot extending from the first opening and the second opening, respectively, towards the interior and structured to receive a first USB plug and a second USB plug, respectively, the first USB plug being different than the second USB plug;
a plurality of first pads positioned within the first slot and arranged to be operably connected to the first USB plug; and
a plurality of second pads positioned within the second slot and arranged to be operably connected to the second USB plug.

2. The USB port system of claim 1, wherein the housing is made of plastic.

3. The USB port system of claim 1, further comprising the first USB circuitry and the second USB circuitry contained within the interior of the housing and being operably connected to the first pads and the second pads, respectively.

4. The USB port system of claim 3, further comprising a plurality of pins positioned at one of the sides and being operably connected to the first USB circuitry and the second USB circuitry.

5. The USB port system of claim 1, wherein the first opening and the second opening are arranged on the same side of the housing.

6. The USB port system of claim 1, wherein the first opening and the second opening are configured in a stacked arrangement on the same side of the housing.

7. The USB port system of claim 1, wherein the first slot is structured to receive one of a 12 Volt USB plug and a 24 Volt USB plug.

8. The USB port system of claim 1, wherein the first slot defines a stop component configured to prevent insertion of one of a 12 Volt USB plug and a 24 Volt USB plug.

9. The USB port system of claim 1, wherein the second pads includes a power pad for providing electrical power to a USB device.

10. The USB port system of claim 1, further comprising a locking mechanism attached to the housing, positioned proximate to the first opening and the second opening, and configured to engage and lock a USB plug system.

11. A universal serial bus (USB) plug system comprising:
a housing including a plurality of sides defining an interior therebetween, and including a first opening and a second opening defined within at least one of the sides;
a first interface and a second interface extending outward from the first opening and the second opening, respectively, and structured to be engage a first USB port and a second USB port, respectively;
a plurality of first pads disposed on the first interface and arranged to be operably connected to the first USB port; and
a plurality of second pads disposed on the second interface and arranged to be operably connected to the second USB port.

12. The USB plug system of claim 11, wherein the housing is made of plastic.

13. The USB plug system of claim 1, further comprising the first USB wiring and the second USB wiring having first ends and second ends, the first ends being contained within the interior of the housing, and being electrically connected to the first pads and the second pads.

14. The USB plug system of claim 13, further comprising a cording defining an interior for containing the second ends of the first USB wiring and the second USB wiring.

15. The USB plug system of claim 11, wherein the first interface and the second interface are arranged on the same side of the housing.

16. The USB plug system of claim 11, wherein the first interface and the second interface are configured in a stacked arrangement on the same side of the housing.

17. The USB plug system of claim 11, wherein the first interface is structured to engage one of a 12 Volt USB port and a 24 Volt USB port.

18. The USB plug system of claim 11, wherein the first interface defines a stop component configured to prevent engagement with one of a 12 Volt USB port and a 24 Volt USB port.

19. The USB plug system of claim 11, wherein the second pads includes a power pad for providing electrical power to a USB device.

20. The USB plug system of claim 11, further comprising a locking mechanism attached to the housing, positioned proximate to the first interface and the second interface, and configured to engage and lock a USB port system.
